(19) United States
(12) Patent Application Publication
(10) Pub. No.: US 2018/0173805 A1
(43) Pub. Date: Jun. 21, 2018

(54) APPLICATION PROGRAMMING INTERFACE FOR DETECTION AND EXTRACTION OF DATA CHANGES

(71) Applicant: SAP SE, Walldorf (DE)

(72) Inventors: Esther Landes, Woerth (DE); Bernhard Thimmel, Edingen-Neckarhausen (DE); Gerald Reinhard, Bruehl (DE); Daniel Goldmann, Mannheim (DE); Dabin Feng, Shanghai (CN); Qendrim Kuqi, Ludwigshafen (DE); Mario Andy Mueller, Muehlhausen (DE); Joachim Pfeifer, Buehl (DE); Oleg Loewen, Wiesloch (DE); Matthias Klauer, Weinheim (DE)

(73) Assignee: SAP SE

(21) Appl. No.: 15/381,437

(22) Filed: Dec. 16, 2016

(51) Int. Cl. G06F 17/30

(52) U.S. Cl. CPC G06F 17/30867; G06F 17/30477

(57) ABSTRACT

A system, a method, and a computer program product for detection and extraction of data are disclosed. A query containing a filtering parameter for extracting changed data from a plurality of resources is executed. Using the filtering parameter, first data in the plurality of resources is identified. Based on the identified first data, second data stored in the plurality of resources and associated with the identified first data is identified. The identified first data is contained in a first resource in the plurality of resources and the second data is contained in a second resource in the plurality of resources. Based on the filtering parameter, a determination is made whether at least one of the identified first data and the identified second data contain at least one change. At least one of the identified first data and the identified second data from the plurality of resources is retrieved.

### TECHNICAL FIELD

This disclosure relates generally to data processing and, in particular, to detection and extraction of data changes in computing systems.

### BACKGROUND

Many companies rely on data to conduct their daily activities. The data can include company data, employee data, financial data, sales data, and/or many other types of data. The data is used to perform a variety of tasks, which can include generation of reports, compilation and/or presentation of various information, data, etc., execution of functionalities of software applications, performing various transactions, etc.

Data can be stored in a variety of ways and is periodically updated through entry of new data, deletion of old data, modification of existing data, and/or in any other way. To retrieve data, a query may be generated that can contain various parameters defining specifics of data that is desired. The queries can be entered using various software applications and their associated user interfaces. Typically, in conventional systems, to access various sources storing data, a separate query may need to be written that is specific to a particular resource. Further, if retrieval of only changed data is required, the existing systems will retrieve all data (changed and not changed), which can significantly burden processing resources, networks, and overall performance of users' computing systems. Thus, there is a need for a way to effectively detect and extract changes to the data without extracting other data.

### SUMMARY

In some implementations, the current subject matter relates to a computer implemented method for detection and extraction of data in computing systems. The method can include executing a query containing at least one filtering parameter for extracting changed data from a plurality of resources, the filtering parameter identifying changed data in the plurality of resources, identifying, using the filtering parameter, a first data in the plurality of resources, identifying, based on the identified first data, a second data stored in the plurality of resources and associated with the identified first data, the identified first data is contained in a first resource in the plurality of resources and the second data is contained in a second resource in the plurality of resources, determining, based on the filtering parameter, whether at least one of the identified first data and the identified second data contain at least one change, and retrieving at least one of the identified first data and the identified second data from the plurality of resources. At least one of the executing, the identifying the first data, the identifying the second data, the determining, and the retrieving can be performed on at least one processor of at least one computing system.

In some implementations, the current subject matter can include one or more of the following optional features. The filtering parameter can be applied to retrieve data from the plurality of resources. In some implementations, the first changed data can include at least one of the following: modified data, added data, deleted data, and any combination thereof.

In some implementations, the first resource and the second resource can include at least one of the following: a root resource and an expand resource. The first resource can be associated with the second resource using at least one association. The first resource and the second resource can include at least one of the following: a supported resource and an unsupported resource. In some implementations, the association can include at least one of the following: a strong association indicating that data in the first resource requires data in the second resource, a weak association indicating that data in the first resource does not require data in the second resource, and an unclassified association.

In some implementations, execution of the query can retrieve changed data from the first resource and second resource when the first and second resources are supported resources associated by a strong association. Alternatively, execution of the query can retrieve changed data from the first resource only, when the first resource is a supported resource and the second resource is an unsupported resource associated with the first resource using a weak association. Further, execution of the query can retrieve changed data from the first resource only, when the first resource is a supported resource and the second resource is a supported resource associated with the first resource using a weak association.

In some implementations, execution of the query does not retrieve any data, when the first resource is an unsupported root resource. Alternatively, execution of the query does not retrieve any data, when the first resource is a supported resource and the second resource is an unsupported expand resource associated with the first resource using a strong association. Moreover, execution of the query does not retrieve any data, when the first resource is a supported resource and the second resource is an unsupported resource associated with the first resource using an unclassified association. Further, execution of the query does not retrieve any data, when the first resource is a supported resource and the second resource is a supported resource associated with the first resource using an unclassified association.

In some implementations, retrieval of data can include retrieving unchanged data associated with at least one of the identified first data and the identified second identified in the query.

In some implementations, the changes to data (e.g., first data and/or second data) can occur during at least one of the following: a predetermined time, a predetermined period of time, after a predetermined time, before a predetermined time, and any combination thereof. These times can be specified by the query (e.g., “last modified” condition) and/or determined by the system based on the query and/or any other factors.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for detection and/or retrieval of changes to data resources, according to some implementations of the current subject matter;

FIG. 2 illustrates an exemplary system of resources, according to some implementations of the current subject matter;

FIG. 3 illustrates an exemplary chart illustrating exemplary associations between resources, according to some implementations of the current subject matter;

FIG. 4 illustrates an exemplary association table, according to some implementations of the current subject matter;

FIG. 5a illustrates an exemplary tree that can be used to navigate between resources in accordance with table shown in FIG. 4;

FIG. 5b illustrates an exemplary navigation tree, according to some implementations of the current subject matter;

FIG. 6 illustrates an exemplary table showing differences between identification of instances between root and expand resources, according to some implementations of the current subject matter;

FIG. 7 is a diagram illustrating an exemplary system including a data storage application, according to some implementations of the current subject matter;

FIG. 8 is a diagram illustrating details of the system of FIG. 7;

FIG. 9 is an exemplary system, according to some implementations of the current subject matter; and

FIG. 10 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide detection and extraction of data changes in computing systems.

In some implementations, the current subject matter can perform detection and/or extraction of data, and in particular changes to data, in computing systems. A query containing at least one filter parameter can be received and processed using an application programming interface. The interface can provide a connection to a plurality of resources that can store data (e.g., databases, memory locations, etc.). The filter parameter can be used to identify data in these resources. Based on the filter parameter, at least one first data that has been changed (added, modified, deleted, or changed in any other way) can be identified as being stored in the plurality of resources. Based on the first changed data, at least one association of the first changed data with a second data can be determined. The second data can be stored in the plurality of resources. The determined association can be classified based a determination that the second data requires the first changed data. Data responsive to the query can be generated, where the data can contain the first changed data and, based on the classification, the second data.

In some implementations, the current subject matter can provide an application programming interface (“API”) along with applicable execution engines that can be used to determine changes to data that may be stored in various resources (e.g., databases, storage locations, etc.) and retrieve the changed data. Some examples of such API can include REST-based APIs that can, based on a receipt of specific query parameters, read out the data contained in a specific resource. For example, the following request can return all email addresses that may exist in a resource system:
GET [service root URI]/PerEmail

In some implementations, the current subject matter can also execute filtering routines that can apply restrictions, filters, etc. to refine output results to a specific subset. For example, using query filter “$filter”, only the email addresses containing ‘cgrantl’ can be returned:
GET [service root URI]/PerEmail?$filter=personIdExternal eq ‘cgrantl’

The above APIs can be used for various purposes, such as displaying and/or arranging data in a user interface (e.g., the above procedure can be used to display ‘cgrantl’ email address). Additionally, the APIs can be used for replication of data from one system to another (e.g., the above procedure can be used to replicate ‘cgrantl’ email information from one system to another), where the other system can use the information for its own applications, procedures, etc. The APIs can also allow retrieval of related data (whether or not such data contains changes) from different resources. For example, a query option “$expand” can be used to return data relating to users and their email addresses:
GET [service root URI]/PerPerson?$expand=emailNav

Conventional systems' APIs are typically unable to provide such capabilities especially in high volume data system-to-system replication scenarios. High volume data replication can be especially important to systems that contain a significant amount of data, e.g., companies' human resources systems holding all employee master data. This data may typically be requested by external systems to offer specific services, e.g. by payroll systems, benefits systems, time management systems, etc. Additionally, not only employee master data might be required, but also company data (e.g., cost center, company unit information, etc.), information on time accounts from positive and negative time management, etc. In conventional systems, a full replication of all data (e.g., all employee master data) has to be done to get the data of all employees into the target systems. However, the data in the source system typically changes frequently (e.g., employee receives a promotion, standard weekly hours are adjusted, employee goes on a leave, etc.), which means that depending on the necessities of the target system, data replication must happen very frequently in order for the target system to have an up-to-date data. This can lead to a high volume data load on the application servers, which can have a substantial impact on the performance of the source and target systems, availability of data, preventing execution of certain routines, etc.

Some approaches at solving this problem can include introduction of a property on every resource that indicates the time when an instance has been last-changed (including application of a filter). The following exemplary request returns only those email entries that have been changed after a specified time:
GET [service root URI]/PerEmail?$filter=lastModifiedOn gt datetime‘2016-06-24T14:00:00’

The following can also be used to find instances that have changed in a specific time frame in the past:
GET [service root URI]/PerEmail?$filter=lastModifiedOn gt datetime‘2015-02-24T16:07:00’ and lastModifiedOn It datetime‘2015-02-24T16:08:00’

However, the above approaches do not provide solutions to replication situations where data contained in several resources must be synchronized in a single operation. Typically, in such situations, root resource information might not be sufficient, where root resource may be required by the user when expand resources have been changed, deleted, etc. and/or when root resource has been completely deleted. Further, the resources might not be built with the same technology and mechanisms to track changes might vary between different resources. As such, modified filters cannot be used and a full replication of data may be required to avoid missing data.

Further, changes on expand resources might not be adequately detected by existing systems. For example, the following filtering mechanism can be used on expand resources:
GET [service root URI]/PerPerson?$expand=emailNav,phoneNav,employmentNav/jobInfoNav& $filter-lastModifiedOn gt datetime‘2016-06-24T14:00:00’ or emailNav/lastModifiedOn gt datetime‘2016-06-24T14:00:00’ or phoneNav/lastModifiedOn gt datetime‘2016-06-24T14:00:00’ or employmentNav/lastModifiedOn gt datetime‘2016-06-24T14:00:00’ or employmentNav/jobInfoNav/lastModifiedOn gt datetime‘2016-06-24T14:00:00’

In the above example, the data responsive to this call can contain all person instances where the person information, the email information, the phone information, the employment information or the job information has been changed. For these changed instances, the person, email, phone, employment and job information can be returned in case this is stated in $expand parameter. However, this approach has various drawbacks. One of the issues can relate to construction of the URL, which can be error-prone. A large request may need to be built, which contains the same information (“lastModifiedOn gt datetime‘2016-06-24T14:00:00”’) several times. In that regard, the maximum URL length can be easily reached. Typically, servers and/or browsers can limit the length of URLs, which can exclude the some of the filtering information. Hence, it might be impossible to execute a single query that asks for all changes to a resource (e.g., master data).

Further, existing systems typically are unable to detect deletion of a root resource. For example, a target system can store data relating to users A, B and C, data relating to user A has been updated, data relating to user D has been added, and data related to user C has been deleted. Conventional querying systems may return data relating to users A and D only without returning any data relating to user C. Hence, data related to a deleted resource may no longer be available and cannot be queried using conventional systems, as conventional querying systems are unable to provide a filtering parameter directed to a deleted resource. Similarly, conventional systems are typically unable to detect deletion of expand resources. For at least similar reasons, it may be difficult for conventional systems to detect any changes to data that may have occurred in the past or supporting different resource implementations.

### I. Single Filtering Parameter

In some implementations, the current subject matter can allow detection of changes (e.g., modification, addition, deletion, etc.) of any resources (e.g., root resources, expand data resources (which can identify data resources into which the system must look into to obtain additional data (i.e., expand into), etc.) across one or more different resources. This can be accomplished without requiring loading of all data from all resources in the event a data change is detected in one or more resources. A resource can be an object, data, a process, an execution routine, etc. related to a software application, a computing system, a database, a memory location, etc., and/or any combination thereof. A resource can be a software application, a computing system, a database, a memory location, etc., and/or any combination thereof. The current subject matter can implement a single filtering parameter that can be applicable across all resources (i.e., root and expand resources) and that can be used to detect and return all changes that may have occurred. The current subject matter can also determine other data resources (e.g., expand data resources) that may contain changes and/or that may be affected by changes in the resources. Such other data resources can be categorized to determine whether their relationship to the initial set of data resources is such that it requires their retrieval.

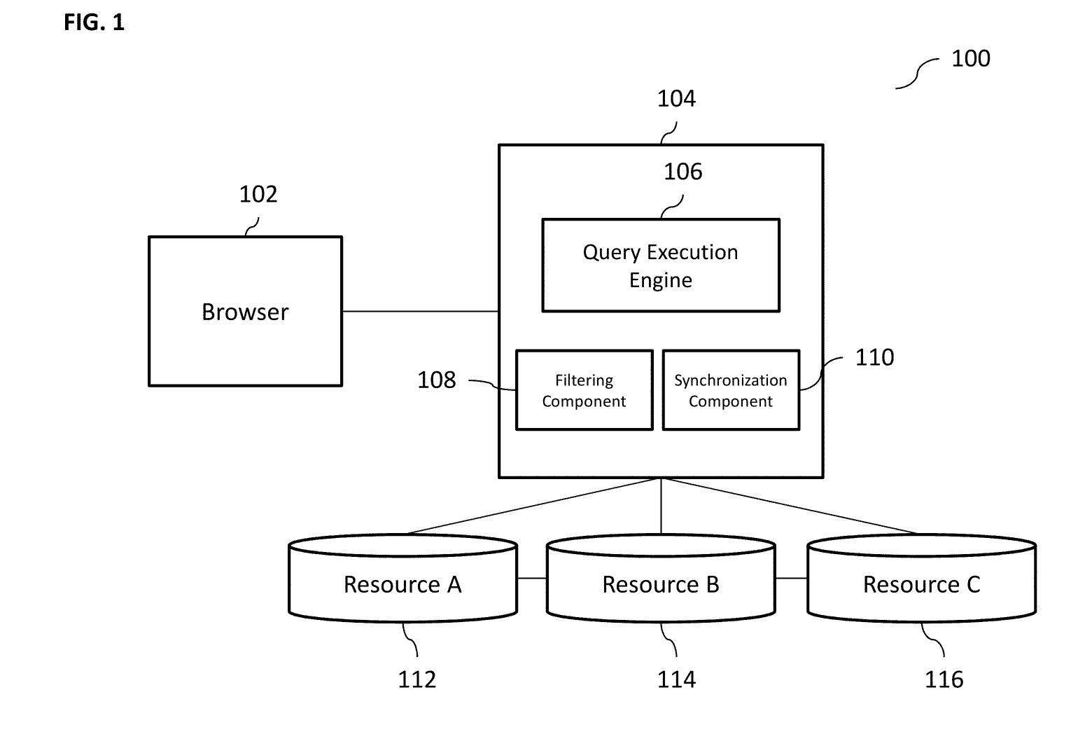

FIG. 1 illustrates an exemplary system 100 for detection and/or retrieval of changes to data resources, according to some implementations of the current subject matter. The system 100 can include a browser component 102, server 104, and a plurality of resources A-C 112-116. The server 104 can include a query execution engine 106, a filtering component 108, and a synchronization component 110. The browser component 102 can be communicatively coupled to the server 104 via a communications network, e.g., an Internet, an intranet, an extranet, a local area network (“LAN”), a wide area network (“WAN”), a metropolitan area network (“MAN”), a virtual local area network (“VLAN”), and/or any other network. The network connection of the browser component 102 and the server 104 can include at least one of the following: a wireless, a wired, and/or any other type of connection. Similarly, the resources 112-116 can be communicatively coupled with the server 104 via a wireless, a wired, and/or any other type of connection. The browser component 102, the server 104, and/or the resources 112-116 can be implemented using software, hardware and/or any combination of both. The browser component 102, the server 104, and/or the resources 112-116 can also be implemented using a personal computer, a laptop, a server, a mobile telephone, a smartphone, a tablet, and/or any other type of device and/or any combination of devices. The browser component 102, the server 104, and/or the resources 112-116 can be separate components and/or can be integrated into one or more single computing components.

The resources 112-116 can include databases, storage location, memory, etc. and/or any combination thereof. The resources 112-116 can store data and can allow querying the stored data (e.g., using SQL queries). The resources can include root resources, expand resources, and/or any other type of resources. In some implementations, the expand resources can be associated, independent, dependent, and/or related to the root resources. For example, a root resource can include a database storing employee information of a company and an expand resource can include a database storing information concerning projects that each employee of the company may be working on. Alternatively, the root resource can contain information about one or more names of employees of a company and expand resource(s) can contain information relating to employee(s)'s addresses, office locations, email addresses, telephone numbers, supervisors, etc.

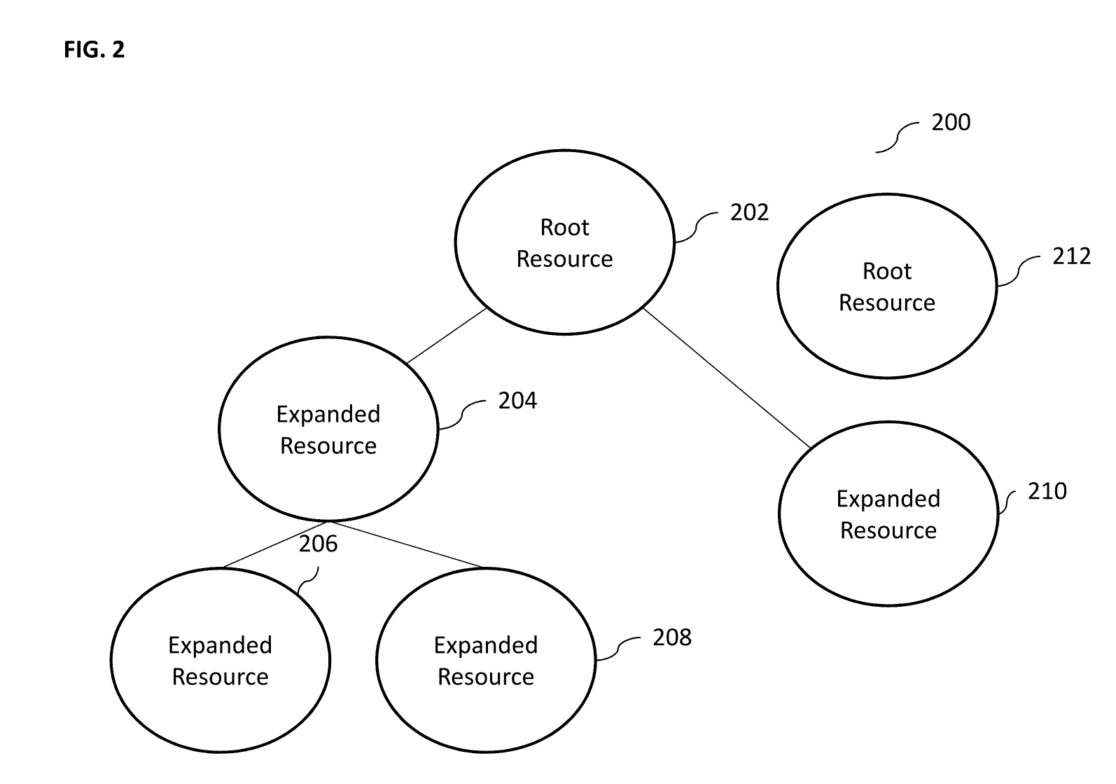

FIG. 2 illustrates an exemplary system of resources 200, according to some implementations of the current subject matter. The system 200 can include a root resource 202 having expand resources 204 and 210, where resources 204, 210 can be associated, dependent, and/or related to the root resource 202. Further, the expand resource 204 can also have expand resources 206 and 208 that may be associated, independent, dependent, and/or related to it. The expand resource 210 may not be associated (or it may not be possible to navigate to) with further expand resources. Further, the system 200 can include a root resource 212 that has no expand resources associated with it (or to which it navigation may not be possible).

Referring back to FIG. 1, the browser component 102 can be used to enter a query or a request to obtain data from one or more resources 112-116. The query can be submitted to the query execution engine 106. The query execution engine 106 can communicate with the filtering component 108 to determine a filtering parameter that can be applicable across all resources 112-116 for the purposes of retrieval of data (including data changes). The synchronization component 110 can be used to ensure that retrieval of data changes across all resources is synchronized and all data changes are presented, based on the filtering parameter, in response to the entered query. The filtering parameter can be selected based on the received query. The filtering parameter can be applied across all resources and/or selected resources. The filtering parameters can include one or more filtering conditions that can be used by the query execution engine in detecting changes to resources and/or retrieval of data.

This can allow for using one filter parameter instead of reiterating the same filter condition for multiple resources. For example, a query seeking data that has been modified since a particular data/time (e.g., “lastModifiedDateTimeFrom”) can be expressed as follows:
GET [service root URI]/PerPerson?$expand-emailNav,phoneNav,employmentNav/jobInfoNav& lastModifiedDateTimeFrom=‘2016-06-24T14:00:00Z’

In order to query changes during a particular timespan, the following query can be used:
GET [service root URI]/PerPerson?$expand=emailNav,phoneNav,employmentNav/jobInfoNav& lastModifiedDateTimeFrom-‘2016-06-24T14:00:00Z’&lastModifiedDateTimeTo-‘2016-06-24T15:00:00Z’

In some implementations, the query execution engine 106 can use one or more predetermined conditions, e.g., the time zone corresponding to UTC. Thus, users submitting queries through the browser 102 do not have to be concerned with specific time zones, where the server 104 may be located in and/or which time zone the system 100 is being operated in. The system 100 can perform requisite determination to convert the result to user's time zone.

The query execution engine 106, upon determination of the filtering parameter, can submit the query to the resources 112-116 and search for any data that has been changed (e.g., modified, deleted, added, etc.). Upon detecting such changed data, the server 104 can return the changed data. The server 104 can also determine whether the changed data is related to, associated with, and/or dependent on one or more other data (e.g., employee name is related to employee email address, etc.) and can determine whether to retrieve such data as well. This determination may be independent of whether such addition data received changes.

### II. Categorization of Associations

In some implementations, the server 104, based on the entered query, can determine whether or not obtain data from additional data resources. The determination can be based on whether additional data resources can be navigated to (e.g., whether navigation to such resources is supported/unsupported), whether such resources exist, whether associations exist with such additional resources (e.g., whether such associations are classified/unclassified), whether data contained in the additional resources is relevant, and/or for any other reasons, and/or any combination thereof. The server 104 can also determine a degree to which one data is associated with another data (e.g., strong, weak, unclassified, etc.) and based on the strength of the association determine whether data in the additional resources can and/or must be obtained/returned in response to the query. For example, changes to data in the root resource may affect one or more expand resources, and hence, the server 104 can determine that data in the expand resources should be returned as well. If there are no changes in the root resources, but a navigation to an expand resource is requested, the data in the root resource and the changed data in the expand resource can be returned.

In some implementations, the server 104 can determine that expansion to other resources should not be performed. One such scenario can include, for example, a situation where the query includes a condition prohibiting expansion to other resources (e.g., a user is not interested nor requires the query to detect changes in expand resources). Further, in some cases, the user might be interested in changes to a certain entity only (e.g., changes to employee data) but nevertheless wants to obtain data associated with such entity (e.g., organizational data such as the assigned department information). When this associated data is changed, it would not trigger a general extraction of data as the associated data change might not be relevant to the user. Additionally, mass changes to a particular resource (e.g., change of a department name) might not always lead to a change to all other affected resources (e.g., employees that are assigned to that department). In such cases, a separate query can be executed on the resource where the mass change was executed on.

In some implementations, the server 104, based on query parameters, can determine which expand resources may need to be included and/or accessed/searched to retrieve further data. The server 104 can determine relationships/associations/dependencies between various data resources (e.g., root resource to expand resource(s), expand resource(s) to further expand resource(s), etc.). The server 104 can determine that two resources may have a strong association or a weak association or no association. A strong association between two resources can exist when one resource requires existence of another resource. For example, the employee name can have a strong association with an employee email in a company system.

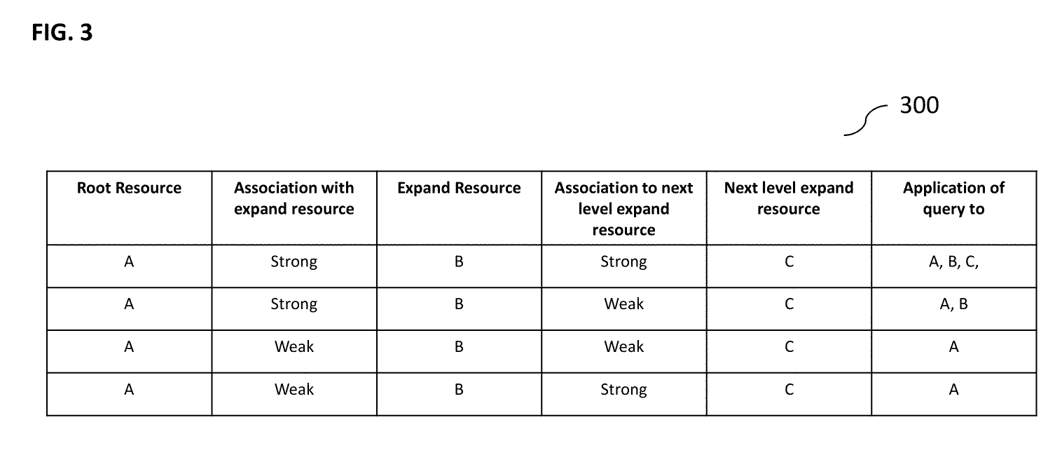

FIG. 3 illustrates an exemplary chart 300 illustrating exemplary associations between resources, according to some implementations of the current subject matter. The shown associations determine which data resources are extracted based on the received query. For example, a root resource A has a strong association with an expand resource B, which in turn, has a strong association with resource C. Thus, a query on resource A will return resources A, B, and C. However, if the root resource A has a weak association with resource B, which in turn has a strong association with resource C, the query will return the resources only in case resource A has changed (due to its weak association with resource B). Hence, the query (e.g., containing the last modified condition) is only applied along the expand chain as long as it reaches a resource via a strong association. For example, assuming a query is requesting navigation from job information to department information to the head of department, the navigation from job to department is weak, as the department information can exist independently of the job information of an employee. When the last modified query is executed on the job information, the query can specify that job information is not to be returned only because a specific field in the department resource (e.g., English translation of the department name) has changed. The department might have further associations, e.g., to the head of department. As the user is not interested on changes on the department itself, the user also might not want to receive job information only because the head of department has changed. Thus, it shall not matter anymore if department and head of department information are in a strong relationship. As the job and department information are in a weak association, the last modified condition is not further applied after the execution on the job information. As shown in FIG. 3, the resources can be associated with one another using a tree-like structure. Thus, a query can be structured to retrieve data in accordance with the tree structure. For example,
GET [service root URI]/PerPerson?$expand=emailNav,phoneNav,employmentNav/jobInfoNav,employmentNav/co mpInfoNav&lastModifiedDateTimeFrom=‘2016-06-24T14:00:00Z’

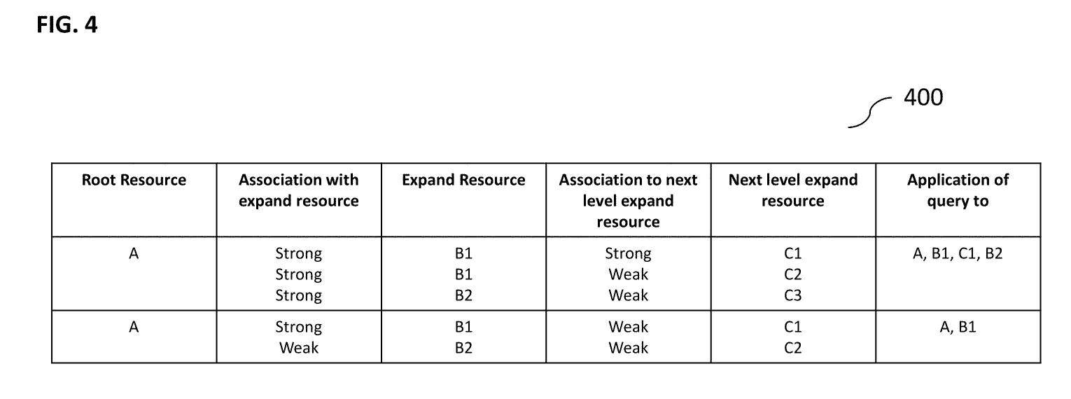

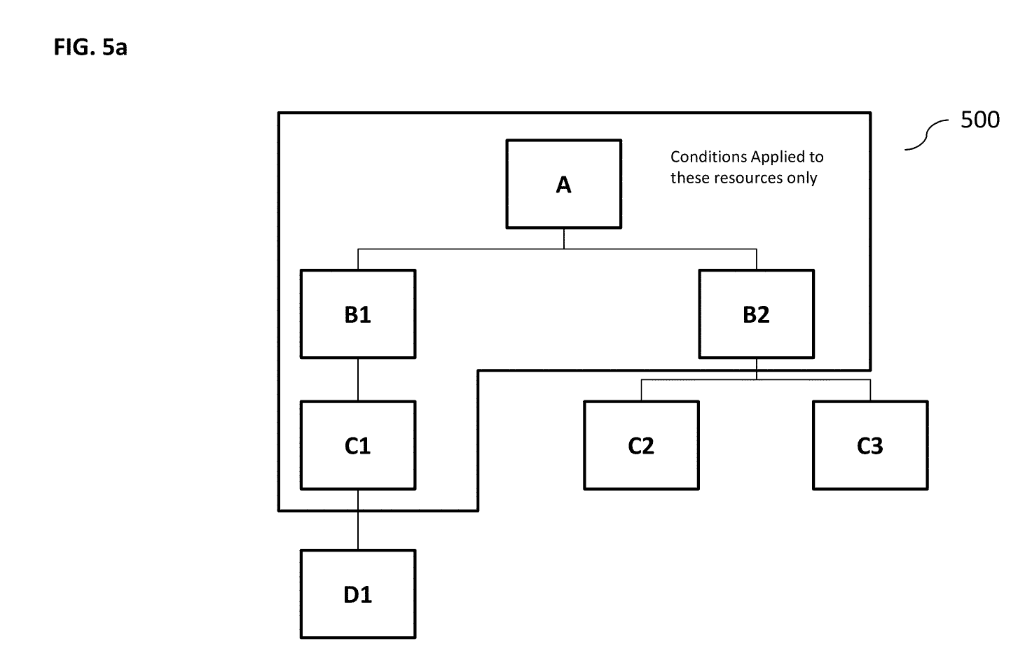

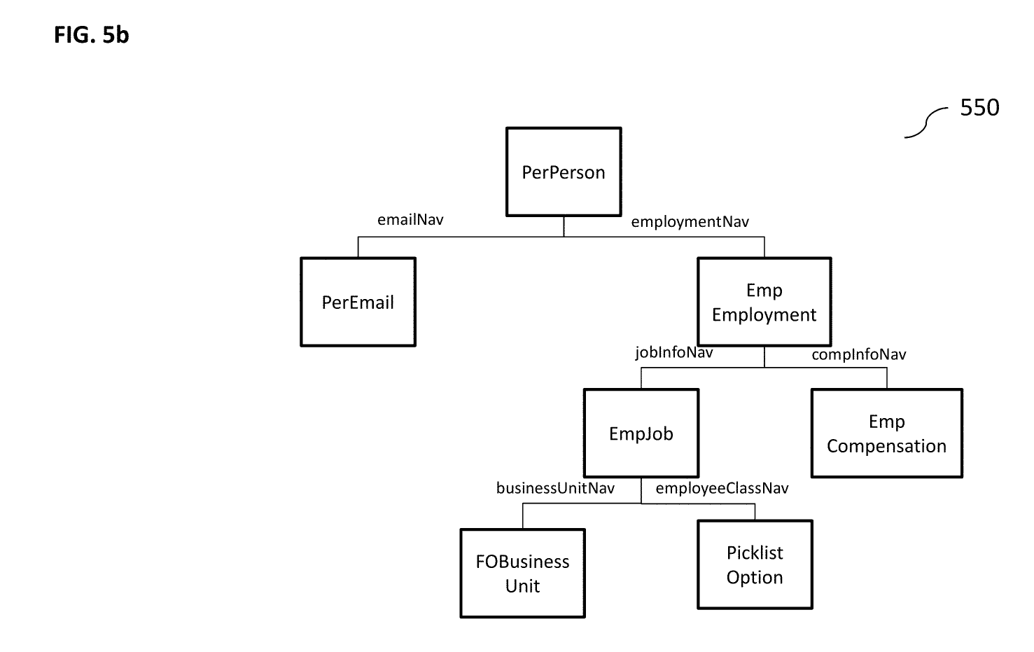

In some implementations, the query can apply the associations (e.g., as shown in FIG. 3) for each branch of the tree. FIG. 4 illustrates an exemplary association table 400 showing a constellation of and/or a grouping of various resources, according to some implementations of the current subject matter. The table 400 illustrates association rules that can be used by the query execution engine to navigate from one resource to another. An exemplary tree 500 that can be used to navigate between resources in accordance with table 400 is shown in FIG. 5a.

As shown in FIG. 4, the table 400 can include a root resource A that has strong associations with expand resources B1 and B2. In this scenario, the expand resource B1 can have a strong association with a next level expand resource C1 and a weak association with a next level expand resource C2; the expand resource B2 can have a weak association with a next level expand resource C3. Because of weak associations with next level resources C2 and C3, the execution of the query can result in a return of A, B1, C1, and B2 resources. In another scenario, root resource A can have a strong association with the expand resource B1 and a weak association with the expand resource B2. Here, B1 expand resource can have a weak association with the next level resource C1 and B2 expand resource can have a weak association with the next level resource C2. Thus, in view of the weak associations between A and B2 and between B1 and C1, the executed query will only extract data if A or B1 has changed.

Referring to FIG. 5, the tree 500 can include an indication that resource A (i.e., root resource) can have a strong association with expand resources B1 and B2 (as shown in table 400), where resource B1 can have a strong association with next level expand resource C1. However, resource B2 has weak associations with expand resources C2 and C3. Another level expand resource D1 can have a weak association with resource C1. The following exemplary query (including “last modified condition”) can be executed using table 400 and tree 500 to obtain various results.
GET [service root URI]/A? $$expand=AB1StrongNav/B1C1StrongNav/C1D1WeakNav/AB2StrongNav/B2C2WeakNav, AB2StrongNav/B2C3WeakNav &lastModifiedDateTimeFrom=‘2016-06-24T14:00:00Z’

The above query indicates that expansion to resources can be performed in accordance with strong and weak associations between various resources A, B1, B2, C1, C2, C3, and D1. In particular, as shown in FIG. 5a, the last modified condition can be applied to the resources A, B1, B2 and C1 due to their associations being strong. The remaining resources are not selected in view of their weak associations and hence, data in those resources might not be returned in response to the query (alternatively, the resources can be returned (if others have changed)).

In some implementations, the current subject matter system can include an application programming interface, which can be communicatively coupled to the server 104 and/or be part of the browser 102 that can be used to define which associations are regarded as strong and/or as weak. The strength/weakness of a particular association can be predetermined by the user submitting a query through the browser. Alternatively, the system (e.g., system 100) can automatically determine strength/weakness of associations between specific resources based on the types of resources, frequency of use resource, importance of information contained in the resources, and/or any other aspects/parameters of the resources. For example, as shown by an exemplar tree 550 in FIG. 5b, resource(s) containing employees' names of a company (e.g., “PerPerson”) can have a strong association (e.g., “emailNav”) with resource(s) containing employees' email addresses (e.g., “PerEmail”). Employees' names resource can also have a strong association (e.g., “employmentNav”) with employees' positions in the company (e.g., “EmpEmployment”) and a strong association (e.g., “jobInfoNav”) with employees' job information (e.g., “EmpJob”). However, resources containing information about business units/departments of the company where employees work (e.g., “FOBusinessUnit”) can have a weak association (e.g., “businesUnitNav”) with the employees' job information (e.g., “EmpJob”) resource. This is because the business units/departments can exist without specific employees. Other associations and their strength/weakness can be preset by a user, predetermined by the system (e.g., by default and/or in any other fashion), selected in the query submitted through the browser, and/or determined in any other way. The query can be used to overrule default associations, such as, when a particular data may be desired.

### III. Phased Implementation

In some implementations, the current subject matter can also process queries (e.g., seeking retrieval of data modified during a particular period of time) that may be directed to resources that may be unsupported and/or have unclassified associations with the root resource(s). For example, such unsupported resources/unclassified associations can be implemented using different technologies, companies, business units, etc., and/or navigation to such resources might be unsupported/unclassified. If the resources are unsupported and/or associations are unclassified, the current subject matter can generate an error message if navigation to such resources and/or via such associations is attempted. However, when resources become supported and/or associations become classified, the current subject matter can permit querying such resources using logic that may be different from the logic that was used when resources were unsupported and/or navigations to resources were unclassified, thereby avoiding generating same error messages.

A. Unsupported Resource

In some implementations, an unsupported resource can include at least one of the following: a resource that has not yet implemented a particular functionality for a queried data, a resource that does not store modified data (but might do so at a later time), and/or any other resource to which access might not be possible at point in time. In some implementations, during development time, resources can initially be categorized as unsupported and when implementation logic for that resource is designed, the resources can become supported at execution time. This can be applicable to root resources and/or expand resources. If the root resource is unsupported, then an error message can be generated regardless of whether expand resources are supported, as shown in Table 1 below:

TABLE 1
Unsupported Root Resource.

| | Association expand | Expand | |
|---|---|---|---|
| | resource of root | resource of | |
| Root Resource | resource | root resource | Result |
| Unsupported | Any | Any | Error message/ |
| | | | termination of |
| | | | processing |

If the root resource is supported and the expand resource is not, the query can obtain last modified information from the root resource only but an error may be generated with regard to the unsupported expand resource.

In some implementations, strength/weakness of the associations between resources can determine whether unsupported resources can be accessed and/or whether any information is returned. For example, as shown in Table 2 below, if a source (e.g., root) resource has a strong association with a target (e.g., expand) resource that is unsupported, an error message can be generated and further processing of the query can be terminated. If the source resource has a weak association with the unsupported target resource, the query for last modified data can be returned for the source resource only and not the target resource. Even if next level expand resources may exist based on the target resource, no further data will be returned (i.e., defining a “boundary” encompassing data that can be returned).

TABLE 2
Unsupported target resources

| | Associa- | | Associa- | Next | |
|---|---|---|---|---|---|
| | tion to | | tion to | level | |
| Source | next level | Target | next level | target | |
| Resource | target | Resource | target | resource | Result |
| Supported | Strong | Unsup- | Any | Any | Error message/ |
| | | ported | | | termination of |
| | | | | | processing |
| Supported | Weak | Unsup- | Any | Any | Last modified |
| | | ported | | | condition is |
| | | | | | applied to the |
| | | | | | source |
| | | | | | resource only |

B. Unclassified Associations

Further, classifications of associations can affect whether or not a particular resource (whether supported or not at any point in time) can be accessed. An unclassified association can be an association for which the final behavior of the association has not been defined yet (e.g., whether/how data in one resource is related, associated, dependent, etc. on data in another resource). Unclassified associations can be used during development when associations between various resources are not yet known, which can relieve the developers from defining associations between resources early in the development process. Once development is complete, unclassified associations can be re-defined for the purposes of detailing how data in resource relates to data in another resource.

As stated above, during system development, associations between various resources can be deemed to be unclassified. Once system implementation logic is provided, which can provide definitions how one resource relates to another resource, the associations between resources can be deemed to be strong, weak, unclassified, and/or defined in any other fashion. Definition of the associations will determine what data (e.g., modified data) is retrieved in response to a query received from the user. For example, if a supported source resource (e.g., a root resource) is associated with an unsupported target resource (e.g., expand resource) using an unclassified association, the query seeking data from both resources will not return any data and an error message may be generated, as shown in Table 3 below. If supported source and supported target resources are associated using an unclassified association, the query seeking retrieval of data from both resources will not return any data and an error message may be generated.

TABLE 3
Unclassified Associations.

| | Associa- | | Associa- | Next | |
|---|---|---|---|---|---|
| | tion to | | tion to | level | |
| Source | next level | Target | next level | target | |
| Resource | target | Resource | target | resource | Result |
| Supported | Unclas- | Unsup- | Any | Any | Error message/ |
| | sified | ported | | | termination of |
| | | | | | processing |
| Supported | Unclas- | Supported | Any | Any | Error message/ |
| | sified | | | | termination of |
| | | | | | processing |

In some implementations, once the associations' designations are finalized (i.e., the system is ready for deployment), changes to the associations' designations might not be permitted. Any time before finalization, associations' designations can be altered as desired. In some implementations, unclassified associations can be used to preliminary define associations between supported/unsupported resources for which it is not yet known how the resources may be associated with one another. Alternatively, the user, upon submission of a query, can specifically define associations between resources, thereby overriding existing associations' designations (in alternate implementations, overriding of associations can be prohibited).

### IV. Unsupported Grouping of Resources

In some implementations, the current subject matter can also respond to queries seeking data that may be contained in various groups of resources that contain various associations that may be impeding detection of changes. For example, the queried data can be contained in transactional tables, which might not store information about past changes. As such, to obtain last modified data, audit tables (i.e., tables that can gather/store changes to data) can be used. The current subject matter and/or the user can determine whether and for which groupings of resources audit tables are to be generated, considered, and/or used. If audit tables have not been generated, a resource can be determined to be unsupported (as defined above), resources for which appropriate permissions have not be granted, resources for which auditing has not been activated or has been deactivated, etc. The current subject matter system can determine a point in time when the auditing has been activated, permissions granted, etc., and use that time to determine when to start recording changes so that appropriate changes to data can be returned in response to the query.

V. Communication of Changes

In some implementations, in response to a query seeking modified data, changes to data can be detected and changed data, as it is currently stored, can be returned. For example, a change of a field (e.g., email address of an employee is changed from “jane.snyder@abc.com” to “jane.foster@abc.com” on 2016-07-01T14:00:00Z) can be retrieved using the following query:
GET [service root URI]/PerPerson?$expand=emailNav& lastModifiedDateTimeFrom=‘2016-07-01T10:00:00Z’

The above query can return data relating to user information of “Jane” together with the email information that contains new email address “jane.foster@abc.com” as well as last modified time of 2016-07-01T14:00:00Z.

A complete deletion of a record (e.g., email information of employee Jane is complete removed from the system on 2016-07-01T14:00:00Z) can be retrieved using the following query:
GET [service root URI]/PerPerson?$expand=emailNav& lastModifiedDateTimeFrom=‘2016-07-01T10:00:00Z’

Using this query, only the data relating to user information of “Jane” is returned, but no email information is returned. By comparing the received data with the data that is already in the system, a determination can be made as to what has happened in the system. Alternatively, the received data can be applied and the existing data in the target resource can consequently be overwritten.

In some exemplary implementations, deletion of a root resource (e.g., person information of Jane is completely removed from the system on 2016-07-01T14:00:00Z) can be retrieved using the following query:
GET [service root URI]/PerPerson?$expand=emailNav& lastModifiedDateTimeFrom=‘2016-07-01T10:00:00Z’

The above query can return data that represents a complete deletion of user (“PerPerson”) resource for employee Jane. In some implementations, the system may contain no information indicating of any changes to the data. For example, an employee can have two job time slices: first, from 2010-01-01 until 2014-07-31, employee worked as a developer and, second, from 2014-08-31 and after, the employee worked as a sales person. Then, the second time slice is deleted. The first one is consequently prolonged and does not end on 2014-07-31 anymore. If a query seeking last modified data is executed, no deleted-entry will be returned, however, the remaining first time slice can be returned (corresponding to an indirect communication of change). If both time slices are deleted, then the deleted entries can be returned indicating that no data is left.

### VI. Instance Identification

In some implementations, the current subject matter, upon receipt of the query, can identify a specific data instance that may have received a change using a key of the resource containing the instance. The key can correspond to any aspect of the data, including predetermined identifiers, metadata, and/or any other parameters that can be used to identify the data. For example, the following code can be used to identify how the instance can be defined for a specific resource:

<EntityType Name=“PerEmail”>

<Key>

<PropertyRef Name=“emailType” />
<PropertyRef Name=“personIdExternal” />

</Key>
<Property Name=“...” Type=“...” .../>
...

</EntityType>

The key can be relevant for the last-modified query on the root resource. For example, if the person Jane has an email address of type “private” and an email address of type “business” and both are deleted, for both addresses, a deleted entry can be returned. In the expand resources, the instances of the expand resources are navigated using identifiers referenced by the root resource. For example, the following can be executed to obtain data from an expand resource:
GET [service root URI]/PerPerson?$expand=emailNav&lastModifiedDateTimeFrom=‘2016-07-01T14:00:00Z’

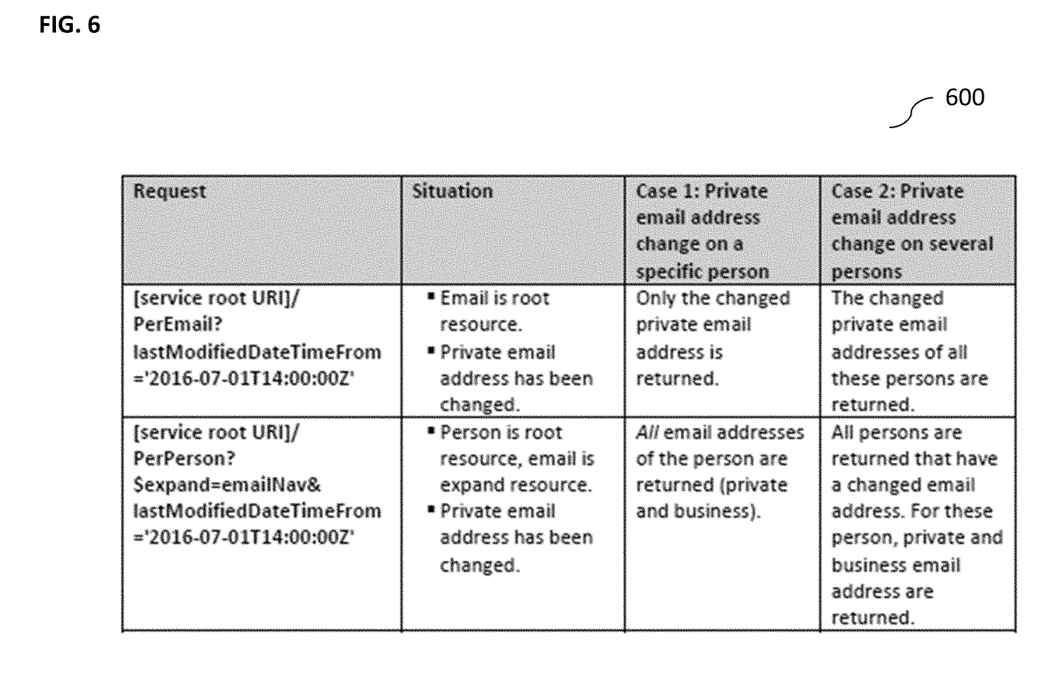

In the above query, it would not matter for the purposes of change detection whether private or business email addresses have changed. For both, the person data can be returned together with the person's current email address. FIG. 6 illustrates an exemplary table 600 showing differences between identification of instances between root and expand resources. For example, for a query seeking identification of changed data associated with an email address (“PerEmail”), if “email” resource is a root resource and an email (e.g., private) address data has changed, the query can return changed email addresses. The changed email addresses can be returned for a specific person, if only data for that specific person is requested (e.g., Case 1 in table 600) or for all persons (e.g., Case 2 in table 600).

If the alternative scenario, a query can be seeking changed data based on specific persons (e.g., “PerPerson”), the “person” resource is a root resource and “email” resource is an expand resource that may be associated with the “person” resource. Similar to the above, the email address data has changed. The query can then return all email address data (e.g., private, business, etc.) associated with the person (e.g., Case 1 in table 600) if changes to email addresses are sought for a specific person. If changes are sought for a plurality of person, then all email address data (e.g., private, business, etc.) is returned for all persons identified in the request.

### 7. Retrieval of Data Changed During a Time Slice

In some implementations, the current subject matter system can retrieve data that has been changed during a particular time slices. A time slice can be a period of time that has a start date and an end date. One or more time slices can exist in the system. The time slices can form a chain, where an end date of the last time slice in chain can last to infinity (until another time slice is created/stored in the system). The start date can correspond to a key that can be used to identify data in the resource. Time slices can be in a single resource and/or each time slice can be a different resource. If the latter case, instances can be identified using keys that do not include the start date. Otherwise, all requisite time slices can be returned depending on the parameters of the query.

Some of the advantages of the current subject matter can include identification of changes that have occurred to data and loading only changed data without transfer of entire data that may include the changed data. This can be particularly useful in situations where changed data may exist in resources that may be linked to one another and/or linked to other resources that may need to be retrieved as well due to the relationships with the changed data. Because data is only returned in case of changes, the current subject matter can reduce network load/congestion. In some implementations, in the query identifies several data resources (e.g., expand data resources), and one or more resources contain changes, all resources identified in the query can be returned. Further, the queries for detecting/retrieving changed data can rely on a single parameter to search multiple resources (including those that have been deleted). Users can also add various conditions on the queries, including identifying specific associations and/or data navigation parameters to customize the query and data that may be received.

In some implementations, the current subject matter can be implemented in various in-memory database systems, such as a High Performance Analytic Appliance (“HANA”) system as developed by SAP SE, Walldorf, Germany. Various systems, such as, enterprise resource planning (“ERP”) system, supply chain management system (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

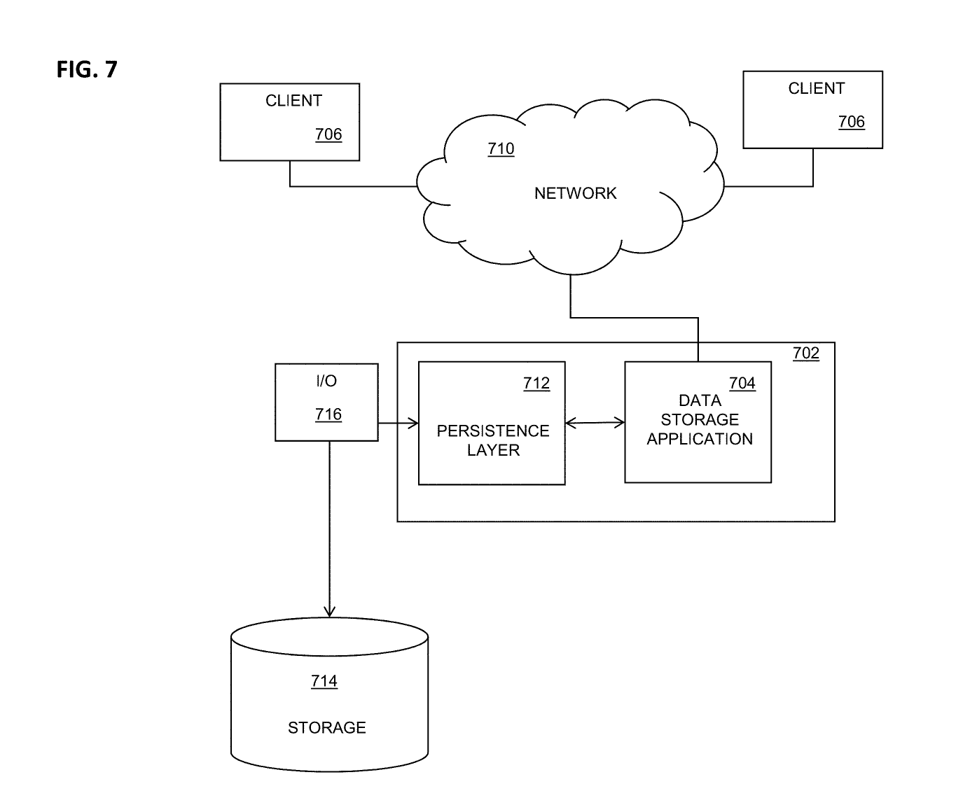

FIG. 7 illustrates an exemplary system 700 in which a computing system 702, which can include one or more programmable processors that can be collocated, linked over one or more networks, etc., executes one or more modules, software components, or the like of a data storage application 704, according to some implementations of the current subject matter. The data storage application 704 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 702 as well as to remote users accessing the computing system 702 from one or more client machines 706 over a network connection 710. One or more user interface screens produced by the one or more first modules can be displayed to a user, either via a local display or via a display associated with one of the client machines 706. Data units of the data storage application 704 can be transiently stored in a persistence layer 712 (e.g., a page buffer or other type of temporary persistency layer), which can write the data, in the form of storage pages, to one or more storages 714, for example via an input/output component 716. The one or more storages 714 can include one or more physical storage media or devices (e.g. hard disk drives, persistent flash memory, random access memory, optical media, magnetic media, and the like) configured for writing data for longer term storage. It should be noted that the storage 714 and the input/output component 716 can be included in the computing system 702 despite their being shown as external to the computing system 702 in FIG. 7.

Data retained at the longer term storage 714 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

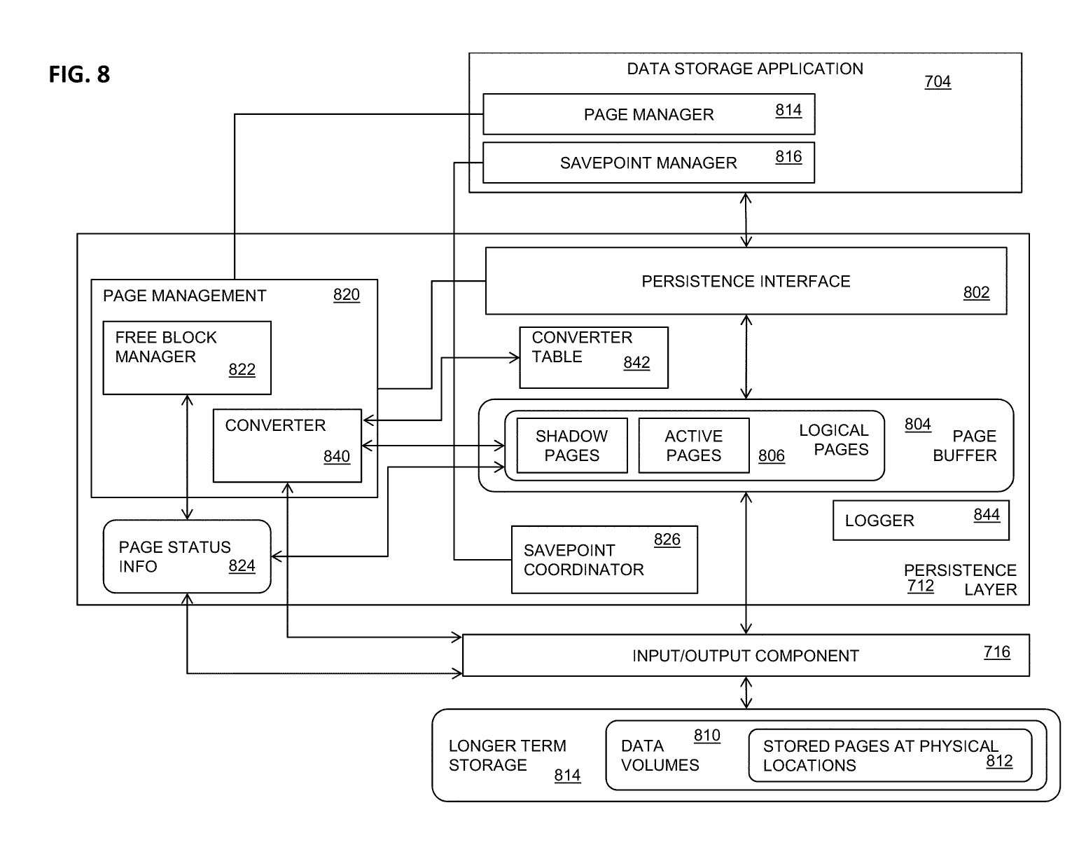

FIG. 8 illustrates exemplary software architecture 800, according to some implementations of the current subject matter. A data storage application 704, which can be implemented in one or more of hardware and software, can include one or more of a database application, a network-attached storage system, or the like. According to at least some implementations of the current subject matter, such a data storage application 704 can include or otherwise interface with a persistence layer 712 or other type of memory buffer, for example via a persistence interface 802. A page buffer 804 within the persistence layer 712 can store one or more logical pages 806, and optionally can include shadow pages, active pages, and the like. The logical pages 806 retained in the persistence layer 712 can be written to a storage (e.g. a longer term storage, etc.) 714 via an input/output component 716, which can be a software module, a sub-system implemented in one or more of software and hardware, or the like. The storage 714 can include one or more data volumes 810 where stored pages 812 are allocated at physical memory blocks.

In some implementations, the data storage application 704 can include or be otherwise in communication with a page manager 814 and/or a savepoint manager 816. The page manager 814 can communicate with a page management module 820 at the persistence layer 712 that can include a free block manager 822 that monitors page status information 824, for example the status of physical pages within the storage 714 and logical pages in the persistence layer 712 (and optionally in the page buffer 804). The savepoint manager 816 can communicate with a savepoint coordinator 826 at the persistence layer 712 to handle savepoints, which are used to create a consistent persistent state of the database for restart after a possible crash.

In some implementations of a data storage application 704, the page management module of the persistence layer 712 can implement a shadow paging. The free block manager 822 within the page management module 820 can maintain the status of physical pages. The page buffer 804 can include a fixed page status buffer that operates as discussed herein. A converter component 840, which can be part of or in communication with the page management module 820, can be responsible for mapping between logical and physical pages written to the storage 714. The converter 840 can maintain the current mapping of logical pages to the corresponding physical pages in a converter table 842. The converter 840 can maintain a current mapping of logical pages 806 to the corresponding physical pages in one or more converter tables 842. When a logical page 806 is read from storage 714, the storage page to be loaded can be looked up from the one or more converter tables 842 using the converter 840. When a logical page is written to storage 714 the first time after a savepoint, a new free physical page is assigned to the logical page. The free block manager 822 marks the new physical page as “used” and the new mapping is stored in the one or more converter tables 842.

The persistence layer 712 can ensure that changes made in the data storage application 704 are durable and that the data storage application 704 can be restored to a most recent committed state after a restart. Writing data to the storage 714 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 844 can also be included to store the changes made to the data of the data storage application in a linear log. The logger component 844 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 844 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 712 can use a combination of undo log entries (from one or more logs) and shadow paging.

The persistence interface 802 can handle read and write requests of stores (e.g., in-memory stores, etc.). The persistence interface 802 can also provide write methods for writing data both with logging and without logging. If the logged write operations are used, the persistence interface 802 invokes the logger 844. In addition, the logger 844 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 844. For an entry of type “update”, for example, this would be the identification of the affected record and the after image of the modified data.

When the data application 704 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 844 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 844 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 844 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 704 can use shadow paging so that the savepoint manager 816 can write a transactionally-consistent savepoint. With such an arrangement, a data backup comprises a copy of all data pages contained in a particular savepoint, which was done as the first step of the data backup process. The current subject matter can be also applied to other types of data page storage.

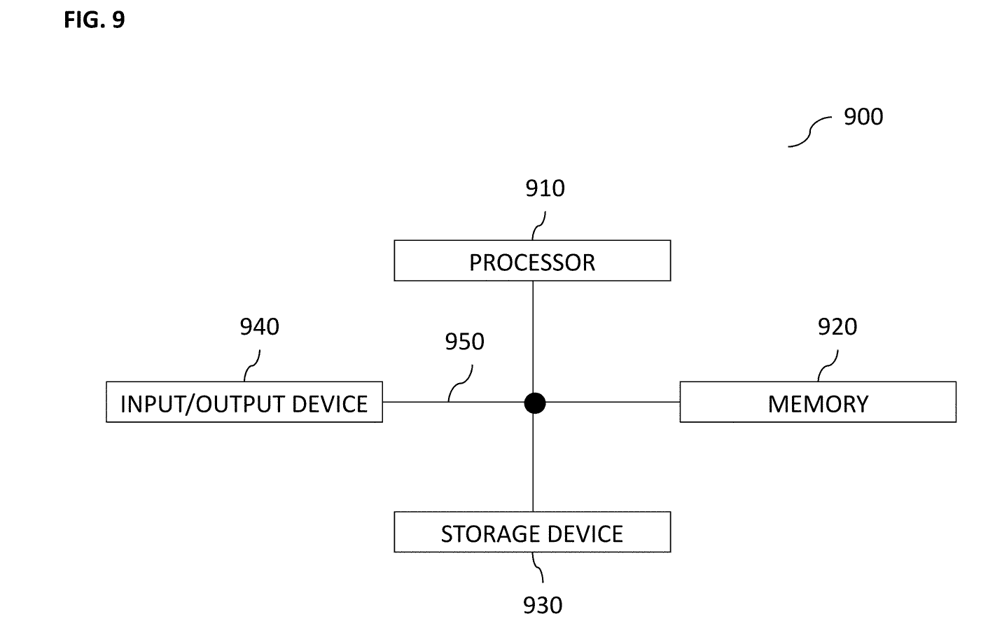

In some implementations, the current subject matter can be configured to be implemented in a system 900, as shown in FIG. 9. The system 900 can include a processor 910, a memory 920, a storage device 930, and an input/output device 940. Each of the components 910, 920, 930 and 940 can be interconnected using a system bus 950. The processor 910 can be configured to process instructions for execution within the system 900. In some implementations, the processor 910 can be a single-threaded processor. In alternate implementations, the processor 910 can be a multi-threaded processor. The processor 910 can be further configured to process instructions stored in the memory 920 or on the storage device 930, including receiving or sending information through the input/output device 940. The memory 920 can store information within the system 900. In some implementations, the memory 920 can be a computer-readable medium. In alternate implementations, the memory 920 can be a volatile memory unit. In yet some implementations, the memory 920 can be a non-volatile memory unit. The storage device 930 can be capable of providing mass storage for the system 900. In some implementations, the storage device 930 can be a computer-readable medium. In alternate implementations, the storage device 930 can be a floppy disk device, a hard disk device, an optical disk device, a tape device, non-volatile solid state memory, or any other type of storage device. The input/output device 940 can be configured to provide input/output operations for the system 900. In some implementations, the input/output device 940 can include a keyboard and/or pointing device. In alternate implementations, the input/output device 940 can include a display unit for displaying graphical user interfaces.

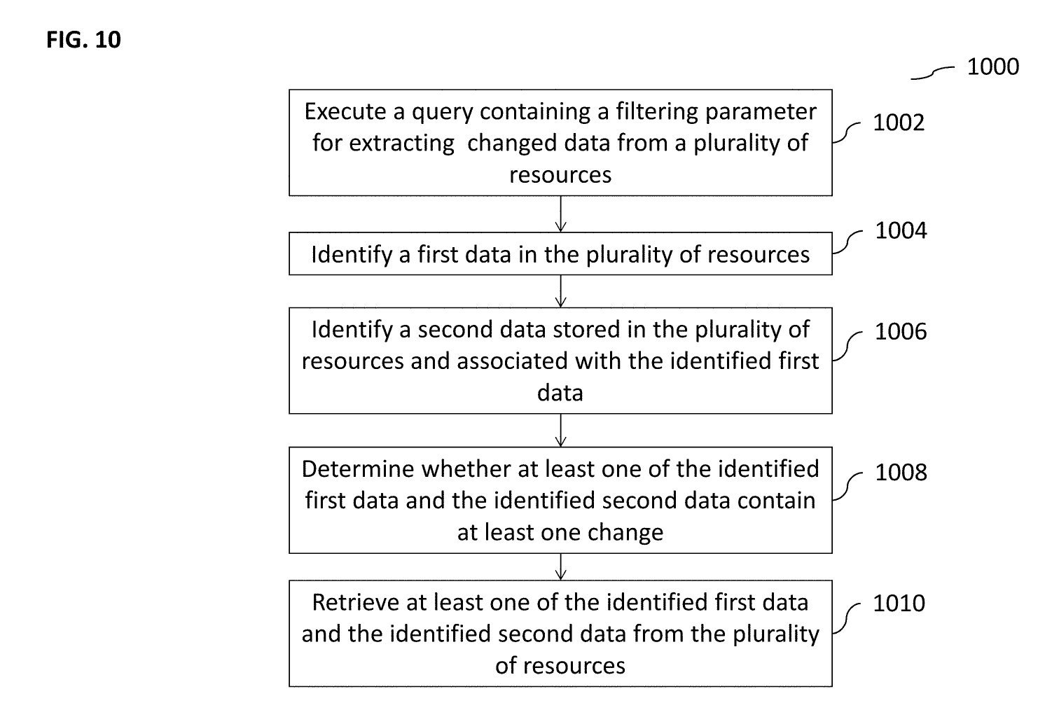

FIG. 10 illustrates an exemplary method 1000 for detection and extraction of data changes are provided, according to some implementations of the current subject matter. At 1002, a query containing at least one filtering parameter (e.g., $filter) for extracting at least one changed data from a plurality of resources can be executed. The filtering parameter can be used to identify changed data in the plurality of resources. A single filtering parameter can be applied across all resources containing data.

At 1004, using the filtering parameter, a first data in the plurality of resources can be identified. At 1006, based on the identified first data, a second data stored in the plurality of resources and associated with the identified first data can be identified. The identified first data can be contained in a first resource in the plurality of resources and the second data can be contained in a second resource in the plurality of resources. The first resource can be a root resource and the second resource can be an expand resource of the root resource.

At 1008, based on the filtering parameter, a determination can be made whether at least one of the identified first data and the identified second data contain at least one change. At 1010, at least one of the identified first data and the identified second data can be retrieved from the plurality of resources.

In some implementations, the current subject matter can include one or more of the following optional features. The filtering parameter can be applied to retrieve data from the plurality of resources. In some implementations, the first changed data can include at least one of the following: modified data, added data, deleted data, and any combination thereof.

In some implementations, the first resource and the second resource can include at least one of the following: a root resource and an expand resource. The first resource can be associated with the second resource using at least one association. The first resource and the second resource can include at least one of the following: a supported resource and an unsupported resource. In some implementations, the association can include at least one of the following: a strong association indicating that data in the first resource requires data in the second resource, a weak association indicating that data in the first resource does not require data in the second resource, and an unclassified association.

In some implementations, execution of the query can retrieve changed data from the first resource and second resource when the first and second resources are supported resources associated by a strong association. Alternatively, execution of the query can retrieve changed data from the first resource only, when the first resource is a supported resource and the second resource is an unsupported resource associated with the first resource using a weak association. Further, execution of the query can retrieve changed data from the first resource only, when the first resource is a supported resource and the second resource is a supported resource associated with the first resource using a weak association.

In some implementations, execution of the query does not retrieve any data, when the first resource is an unsupported root resource. Alternatively, execution of the query does not retrieve any data, when the first resource is a supported resource and the second resource is an unsupported expand resource associated with the first resource using a strong association. Moreover, execution of the query does not retrieve any data, when the first resource is a supported resource and the second resource is an unsupported resource associated with the first resource using an unclassified association. Further, execution of the query does not retrieve any data, when the first resource is a supported resource and the second resource is a supported resource associated with the first resource using an unclassified association.

In some implementations, retrieval of data can include retrieving unchanged data associated with at least one of the identified first data and the identified second identified in the query.

In some implementations, the changes to data (e.g., first data and/or second data) can occur during at least one of the following: a predetermined time, a predetermined period of time, after a predetermined time, before a predetermined time, and any combination thereof. These times can be specified by the query (e.g., “last modified” condition) and/or determined by the system based on the query and/or any other factors.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
executing a query containing at least one filtering parameter for extracting changed data from a plurality of resources, the filtering parameter identifying changed data in the plurality of resources;
identifying, using the filtering parameter, a first data in the plurality of resources;
identifying, based on the identified first data, a second data stored in the plurality of resources and associated with the identified first data, the identified first data is contained in a first resource in the plurality of resources and the second data is contained in a second resource in the plurality of resources;
determining, based on the filtering parameter, whether at least one of the identified first data and the identified second data contain at least one change; and
retrieving at least one of the identified first data and the identified second data from the plurality of resources;
wherein at least one of the executing, the identifying the first data, the identifying the second data, the determining, and the retrieving is performed on at least one processor of at least one computing system.

2. The method according to claim 1, wherein the filtering parameter is applied to retrieve data from the plurality of resources.

3. The method according to claim 1, wherein changes to one of the identified first data and the identified second data includes at least one of the following: a modified data, an added data, a deleted data, and any combination thereof.

4. The method according to claim 1, wherein the first resource and the second resource include at least one of the following: a root resource and an expand resource;
the first resource is associated with the second resource using at least one association.

5. The method according to claim 4, wherein the first resource and the second resource include at least one of the following: a supported resource and an unsupported resource.

6. The method according to claim 5, wherein the association includes at least one of the following: a strong association indicating that data in the first resource requires data in the second resource, a weak association indicating that data in the first resource does not require data in the second resource, and an unclassified association.

7. The method according to claim 6, wherein execution of the query retrieves changed data from
the first resource and second resource when the first and second resources are supported resources associated by a strong association;
the first resource only, when the first resource is a supported resource and the second resource is an unsupported resource associated with the first resource using a weak association;
the first resource only, when the first resource is a supported resource and the second resource is a supported resource associated with the first resource using a weak association.

8. The method according to claim 6, wherein execution of the query does not retrieve any data, when
the first resource is an unsupported root resource;
the first resource is a supported resource and the second resource is an unsupported expand resource associated with the first resource using a strong association;
the first resource is a supported resource and the second resource is an unsupported resource associated with the first resource using an unclassified association;
the first resource is a supported resource and the second resource is a supported resource associated with the first resource using an unclassified association.

9. The method according to claim 1, wherein the retrieving further comprises
retrieving unchanged data associated with at least one of the identified first data and the identified second identified in the query.

10. The method according to claim to claim 1, wherein the at least one change occurred during at least one of the following: a predetermined time, a predetermined period of time, after a predetermined time, before a predetermined time, and any combination thereof.

11. A system comprising:
at least one programmable processor; and
a machine-readable medium storing instructions that, when executed by the at least one programmable processor, cause the at least one programmable processor to perform operations comprising:
executing a query containing at least one filtering parameter for extracting changed data from a plurality of resources, the filtering parameter identifying changed data in the plurality of resources;
identifying, using the filtering parameter, a first data in the plurality of resources;
identifying, based on the identified first data, a second data stored in the plurality of resources and associated with the identified first data, the identified first data is contained in a first resource in the plurality of resources and the second data is contained in a second resource in the plurality of resources;
determining, based on the filtering parameter, whether at least one of the identified first data and the identified second data contain at least one change; and
retrieving at least one of the identified first data and the identified second data from the plurality of resources.

12. The system according to claim 11, wherein the filtering parameter is applied to retrieve data from the plurality of resources.

13. The system according to claim 11, wherein changes to one of the identified first data and the identified second data includes at least one of the following: a modified data, an added data, a deleted data, and any combination thereof.

14. The system according to claim 11, wherein the first resource and the second resource include at least one of the following: a root resource and an expand resource;
the first resource is associated with the second resource using at least one association.

15. The system according to claim 14, wherein the first resource and the second resource include at least one of the following: a supported resource and an unsupported resource;
wherein the association includes at least one of the following: a strong association indicating that data in the first resource requires data in the second resource, a weak association indicating that data in the first resource does not require data in the second resource, and an unclassified association.

16. The system according to claim 15, wherein execution of the query retrieves changed data from
the first resource and second resource when the first and second resources are supported resources associated by a strong association;
the first resource only, when the first resource is a supported resource and the second resource is an unsupported resource associated with the first resource using a weak association;
the first resource only, when the first resource is a supported resource and the second resource is a supported resource associated with the first resource using a weak association.

17. The system according to claim 15, wherein execution of the query does not retrieve any data, when
the first resource is an unsupported root resource;
the first resource is a supported resource and the second resource is an unsupported expand resource associated with the first resource using a strong association;
the first resource is a supported resource and the second resource is an unsupported resource associated with the first resource using an unclassified association;
the first resource is a supported resource and the second resource is a supported resource associated with the first resource using an unclassified association.

18. The system according to claim 11, wherein the retrieving further comprises
retrieving unchanged data associated with at least one of the identified first data and the identified second identified in the query.

19. The system according to claim 11, wherein the at least one change occurred during at least one of the following: a predetermined time, a predetermined period of time, after a predetermined time, before a predetermined time, and any combination thereof.

20. A computer program product comprising a non-transitory machine-readable medium storing instructions that, when executed by at least one programmable processor, cause the at least one programmable processor to perform operations comprising:
executing a query containing at least one filtering parameter for extracting changed data from a plurality of resources, the filtering parameter identifying changed data in the plurality of resources;
identifying, using the filtering parameter, a first data in the plurality of resources;
identifying, based on the identified first data, a second data stored in the plurality of resources and associated with the identified first data, the identified first data is contained in a first resource in the plurality of resources and the second data is contained in a second resource in the plurality of resources;
determining, based on the filtering parameter, whether at least one of the identified first data and the identified second data contain at least one change; and
retrieving at least one of the identified first data and the identified second data from the plurality of resources.
